(19) United States
(12) Patent Application Publication
(10) Pub. No.: US 2014/0116170 A1
(43) Pub. Date: May 1, 2014

(54) In-line shift bevel gear forward/reverse

(71) Applicant: Anthony W. Fini, JR., Blasdell, NY (US)

(72) Inventor: Anthony W. Fini, JR., Blasdell, NY (US)

(21) Appl. No.: 13/694,185

(22) Filed: Nov. 1, 2012

(51) Int. Cl. F16H 3/22

(52) U.S. Cl. CPC F16H 3/22
USPC 74/350

(57) ABSTRACT

An in-line shift bevel gear forward/reverse mechanism comprises bevel gears, a locking device for forward drive and a stop means for reverse drive. The locking device includes a female spline mounted to a differential unit and a male spline mounted to a flanged hub which is slidably mounted on an input shaft of the mechanism and locks the input shaft to the differential unit for forward drive. The differential unit is automatically unlocked when linkage means actuates a stop means for the differential unit and stops the differential unit from rotating for reverse drive. The mechanism also provides a neutral.

### BACKGROUND OF THE INVENTION

A practical reverse drive for some motor vehicles is a necessity. U.S. Pat. No. 5,394,764 describes a practical and inexpensive method for forward and reverse drive. This invention offers utility for many applications but is ideal for mechanical torque converters. The Patent does state that the actuation levers could be combined so that they work in unison and only one control would then be necessary for forward or reverse drive. However no specific method of how to accomplish this is shown or described. In addition the invention shows and describes a band brake being used as the stop means for the differential unit making one lever control even more complex or difficult.

### SUMMARY

The present invention is directed towards achieving forward and reverse in one straight in-line action. Two preferred embodiments of the invention are described. The stop means employed is the difference between the two. Both of them use a very similar in-line linkage means to accomplish forward and reverse drive with neutral in between. The invention is very simple and utilitarian.

### DRAWINGS

FIG. 1 is a top view illustrating a preferred embodiment of the invention. The differential unit is partially cut away to show internal parts. The invention is shown in its entirety with a complete mounting means.

FIG. 2 is a top view illustrating a different operation mode of the invention.

FIG. 3 is a top view also illustrating a different operation mode of the invention.

FIG. 4 is a partial side view illustrating a stop means of the invention.

FIG. 5 is an enlarged top view illustrating a similar also preferred embodiment of the invention.

FIG. 6 is a partial side view of FIG. 5 illustrating part of the stop means of the invention.

FIGS. 7A and 7B are partial front views of FIG. 5 also illustrating the stop means of the invention.

Reference Charactors and Parts to Which They Refer

| | |
|---|---|
| 1 | Shift Arm |
| 2 | Shift Arm |
| 3 | Actuator |
| 4 | Bearing |
| 5 | Bearing |
| 6 | Input Shaft |
| 7 | Output Shaft |
| 8 | Differential Unit |
| 9 | Differential Bearing |
| 10 | Bevel Gear |
| 11 | Bevel Gear |
| 12 | Bevel Gear |
| 13 | Pinion Shaft |
| 14 | Through Bolts |
| 15 | Sprocket |
| 16 | Female Spline |
| 17 | Male Spline |
| 18 | Hub |
| 19 | Key |
| 20 | Swivel bolt |
| 21 | Fork |
| 22 | Stop Plate |
| 23 | Swivel Bolt |
| 24 | Link Plate |
| 25 | Swivel Bolt |
| 26 | Swivel Bolt |
| 27 | Hold Down Plate |
| 28 | Hold Down Bolt |
| 29 | Frame |
| 30 | Frame Bearing Support |
| 31 | Slot |
| 32 | Disk |
| 33 | Guide Block |
| 34 | Block Bolts |
| 35 | Pin |
| 36 | Swivel Pin |
| 37 | Swivel Pin |
| 38 | Disk holes |
| 39 | Shift arm hole |
| 40 | Shift arm hole |

### DESCRIPTION OF THE INVENTION

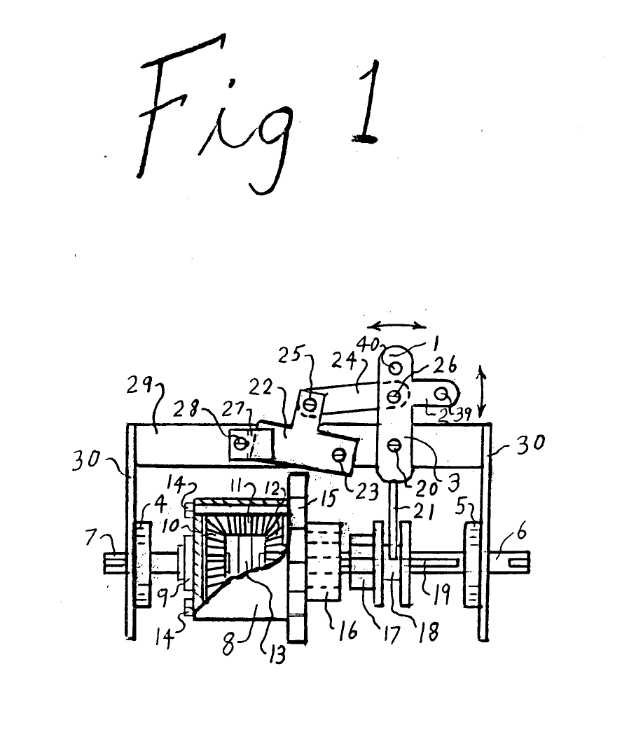

In FIG. 1 the frame 29 and frame bearing supports 30 may be connected by any suitable means such as bolts, weld or can even be one-piece and serve as a mounting means. The bearings 4 and 5 are mounted in the bearing supports 30. Both the input shaft 6 and the output shaft 7 are mounted in these bearings 4 and 5. Bearings 10 are also mounted on each side of the differential unit 8 and support the unit on the input and output shafts. Inside the differential unit 8 a bevel gear 12 is mounted on the input shaft 6 and a bevel gear 10 is mounted on the output shaft 7. These bevel gears are in mesh with a third bevel gear 11 rotatably mounted on a pinion shaft 13 which is securely mounted inside the differential unit 8. A fourth bevel gear mounted on the opposite end of the pinion shaft, not shown, is optional and used for both balance and strength. A large chain sprocket 15 with a female spline 16 attached to it is mounted to the differential unit 8 and secured by through bolts 14. A male spline 17 with a hub 18 is slidably mounted on the input shaft 6 on a key 19 so that when the male spline 17 is slid into the female spline 16 the differential is locked and the input shaft 6 drives the output shaft 7. In this drawing figure the mechanism is in a neutral position and when the output shaft 7 is held stopped and rotational power applied to the input shaft 6, only the differential unit 8 rotates. With all gears being of the same size, it rotates at half the speed of the input shaft 6. An actuator 3 is mounted to the frame 29 with a swivel bolt 20. The actuator 3 has a fork 21 on its end and the fork 21 rests in the hub 18. The shift arms 1 and 2 are integral with the actuator 3 and move the actuator 3 with the fork 21 and hub 18 with the male spline 17 from right to left and vice versa. A handle or rod and lever, not shown, would be connected to the shift arms 1 and 2 in the shift arm holes 39 and 40 in the mechanism installation. The reason for the two arms 1 and 2 is so the mechanism can be mounted and used in a conventional or in a transverse mode as for example when used in an automobile. A stop plate 22 is mounted on another swivel bolt 23 and can easily wedge itself into the large chain sprocket 15 by means of a link plate 24 connecting the actuator 3 to the stop plate 22 with swivel bolts 25 and 26. A hold down plate 27 secured by a bolt 28 serves as a guide and gives the stop plate 22 additional support strength.

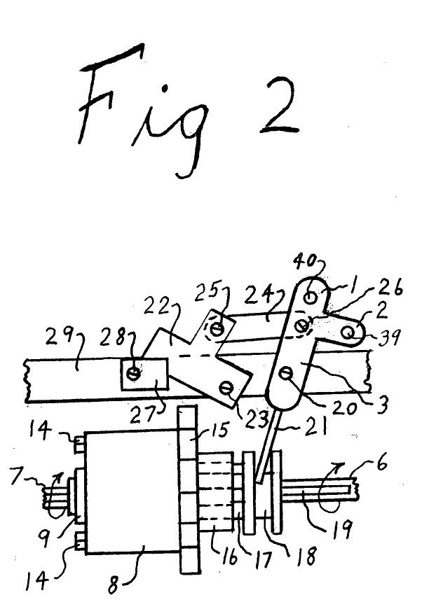

As shown in FIG. 2, the mechanism is shifted into forward drive wherein the stop plate 22 is even more clear of the sprocket 15 than it was in FIG. 1, or the neutral position, the male and female splines 16 and 17 are joined, and the differential unit 8 is locked and the input shaft 6 and the output shaft 7 rotate in the same direction.

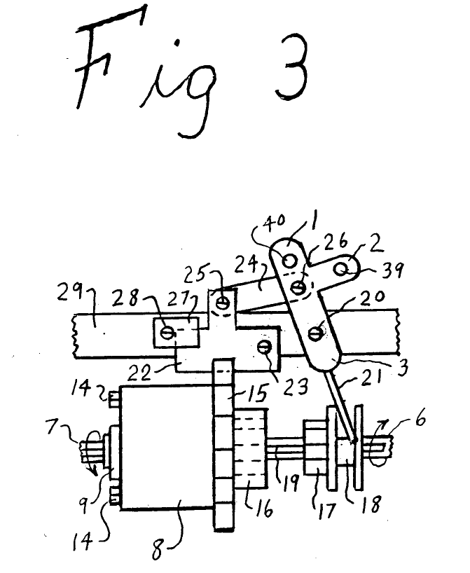

In FIG. 3 the actuator 3 disengages the splines 16 and 17 even further apart than in FIG. 1, or the neutral position, while at the same time the linkage means moves the stop plate 22 into the sprocket 15 stopping the differential unit 8 and the output shaft 7 rotates in the opposite direction of the input shaft 6 thereby providing reverse drive.

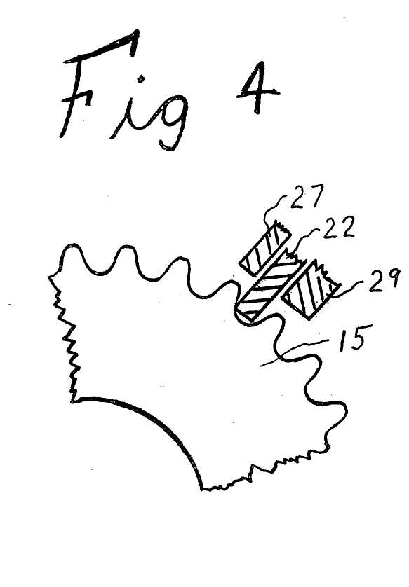

FIG. 4 is enlarged and shows more clearly how the large chain sprocket 15 is securely stopped and held from rotation by the stop plate 22.

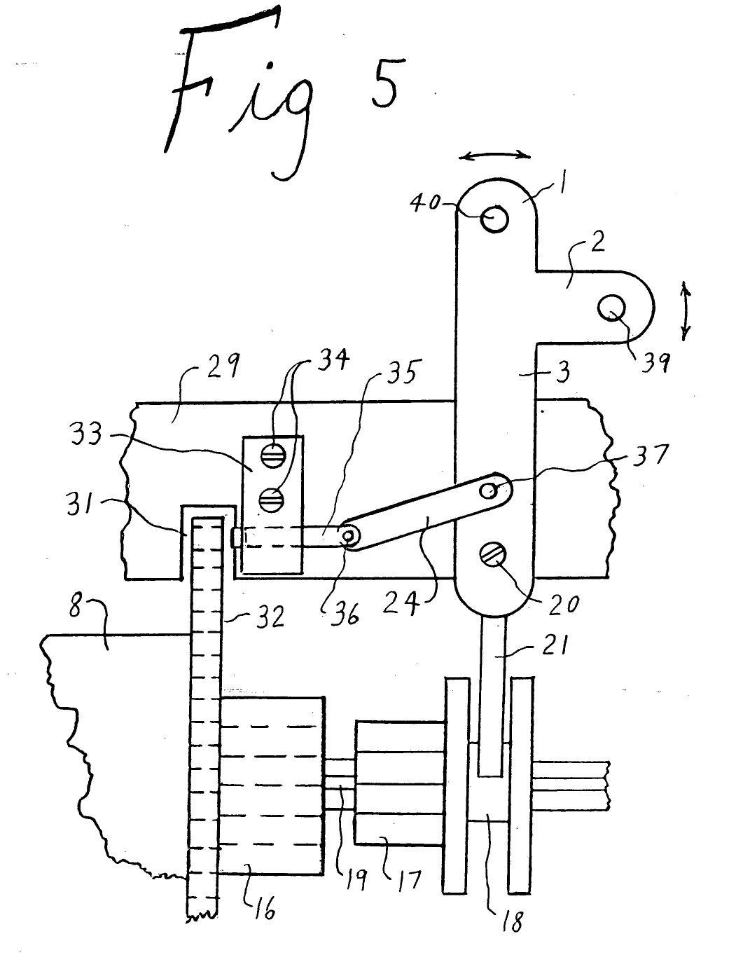

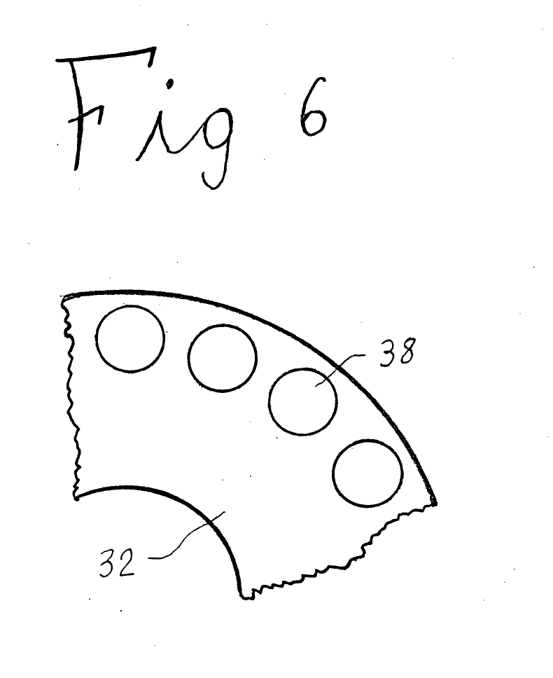

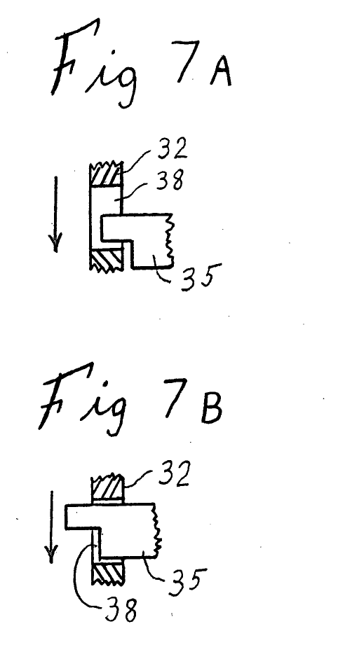

FIG. 5 shows the invention utilizing a disk 32 with a pin 35 to stop the differential unit 8. The pin 35 is housed and supported by a guide block 33 held down on the frame 29 by bolts 34. The pin 35 is also connected to the actuator 3 by the link plate 24 with swivel pins 36 and 37. A slot 31 is cut in the frame 29 for construction convenience and the disk 32, with holes 38 along its periphery as shown in FIG. 6, moves through it. The disk holes 38 are slightly larger than the pin 35. FIGS. 7A and 7B shows that the end of the pin 35 can be stepped so that the pin 35 more easily enters a hole 38 of the disk 32 even if there is a slight drag and revolving motion on the input shaft of the mechanism.

The invention provides forward, neutral and reverse all in an in-line actuation manner.

I claim:

1. An in-line shift forward and reverse mechanism comprising:
a first bevel gear mounted on an input shaft to be driven by said input shaft;
a second bevel gear mounted on an output shaft for driving said output shaft;
a mounting means, bearings on said mounting means, said input and output shafts mounted in said bearings;
a third bevel gear mounted on a pinion shaft for rotation thereon;
a differential unit for mounting said pinion shaft so that said third bevel gear is in mesh with said first and second bevel gear, wherein said differential unit and/or said output shaft are rotatably driven by said input shaft;
a stop means for said differential unit for stopping said differential unit from rotation or releasing said differential unit for rotation, a means for locking said input shaft to said differential unit wherein said bevel gears-are also locked relative to the input shaft;
an in-line linkage means on said mounting means, said linkage means is connected to said stop means and said locking means, said linkage means actuating said stop means and said locking means so that when said stop means releases said differential unit for rotation, said means for locking said input shaft to said differential unit locks said bevel gears relative to said input shaft, said input shaft rotates said output shaft in the same direction but when said stop means stops said differential unit from rotation, said differential unit is not locked to said input shaft, said input shaft rotates said output shaft in the opposite direction whereby forward and reverse drive is provided.

2. A mechanism as specified in claim 1, wherein said linkage means is comprised of plates with swivel bolts connecting said plates to said mounting means and said stop means is a large chain sprocket mounted on said differential unit and a stop plate on said mounting means, said stop plate is actuated by said linkage means and wedges into said sprocket thereby stopping said differential unit.

3. A mechanism as specified in claim 1, wherein said linkage means is comprised of plates with swivel bolts and swivel pins connecting said plates to said mounting means, said stop means is a disk mounted on said differential unit, said disk having holes about its periphery and a pin slidably mounted in a guide block on said mounting means, said pin is actuated by said linkage means and enters said disk holes thereby stopping said differential unit.

4. A mechanism as specified in claim 1, wherein said means for locking said input shaft to said differential unit comprises a female spline mounted on said differential unit and a male spline slidably mounted along a key on said input shaft so that said male spline can be slid into said female spline by said linkage means thereby locking said input shaft to said differential unit.

5. An in-line shift mechanism wherein said stop means is not stopping said differential unit by said linkage means and said means for locking said differential unit to said input shaft is unlocked by said linkage means whereby said mechanism has neutral between the forward and reverse shift.

6. An in-line shift forward and reverse mechanism comprising:
a first bevel gear mounted on an input shaft to be driven by said input shaft;
a mounting means, bearings on said mounting means, said input and said output shafts mounted in said bearings;
a second bevel gear mounted on an output shaft for driving said output shaft;
a third bevel gear mounted on a pinion shaft for rotation thereon;
a differential unit for mounting said pinion shaft so that said third bevel gear is in mesh with said first and second bevel gear, wherein said differential unit and/or said output shaft are rotatably driven by said input shaft;
a stop means mounted on said differential unit for stopping said differential unit from rotation or releasing said differential unit for rotation, said stop means is a sprocket mounted on said differential unit and a stop plate wedges into said sprocket thereby stopping said differential unit; a means for locking said input shaft to said differential unit wherein said bevel gears are also locked relative to the input shaft;
an in-line linkage means on said mounting means, said linkage means is connected to said stop means and said locking means, said linkage means actuating said stop means and said locking means so that when said stop means releases said differential unit for rotation, said means for locking said input shaft to said differential unit locks said bevel gears relative to said input shaft, said input shaft rotates said output shaft in the same direction but when said stop means stops said differential unit from rotation, said differential unit is not locked to said input shaft, said input shaft rotates said output shaft in the opposite direction whereby forward and reverse drive is provided.

7. An in-line shift forward and reverse mechanism comprising:
a first bevel gear mounted on an input shaft to be driven by said input shaft;
a second bevel gear mounted on an output shaft for driving said output shaft;
a mounting means, bearings on said mounting means, said input and said output shafts mounted in said bearings;
a third bevel gear mounted on a pinion shaft for rotation thereon;
a differential unit for mounting said pinion shaft so that said third bevel gear is in mesh with said first and second bevel gear, wherein said differential unit and/or said output shaft are rotatably driven by said input shaft;
a stop means mounted on said differential unit for stopping said differential unit from rotation or releasing said differential unit for rotation, said stop means is a disk having holes about its periphery and a pin slidably mounted in a guide block, said pin enters said disk holes thereby stopping said differential unit, a means for locking said input shaft to said differential unit wherein said bevel gears are also locked relative to the input shaft;
an in-line linkage means on said mounting means, said linkage means is connected to said stop means and said locking means, said linkage means actuating said stop means and said locking means so that when said stop means releases said differential unit for rotation, said means for locking said input shaft to said differential unit locks said bevel gears relative to said input shaft, said input shaft rotates said output shaft in the same direction but when said stop means stops said differential unit from rotation, said differential unit is not locked to said input shaft, said input shaft rotates said output shaft in the opposite direction whereby forward and reverse drive is provided.
